(19) United States
(12) Patent Application Publication
(10) Pub. No.: US 2026/0266298 A1
(43) Pub. Date: Sep. 10, 2026

(54) VACUUM PUMP AND STATOR COMPONENT

(71) Applicant: Edwards Japan Limited, Chiba (JP)

(72) Inventors: Yasuhiro Shibata, Chiba (JP); Kentaro Sato, Chiba (JP)

(21) Appl. No.: 18/994,394

(22) PCT Filed: Aug. 23, 2023
(86) PCT No.: PCT/JP2023/030312

§ 371 Date: Nov. 4, 2025

(30) Foreign Application Priority Data
Aug. 25, 2022 (JP) 2022-134228

(51) Int. Cl. F04D 19/04; F04D 29/52; F04D 29/58

(52) U.S. Cl. CPC F04D 19/042; F04D 29/522; F04D 29/5853

(57) ABSTRACT

A vacuum pump includes a casing, a rotor shaft enclosed in the casing and rotatably supported, a rotor fixed to the rotor shaft and rotated with the rotor shaft, and an annular stator component which exhausts a sucked-in gas in collaboration with the rotor. The stator component has a first part and a second part formed by casting and opposed by sandwiching at least one reducing groove reducing a volume and extending along a circumferential direction of the stator component and a bottom portion which is disposed by containing at least a bottom of the reducing groove and connects the first part and the second part, and the stator component includes a heat-transfer improving structure which improves heat transfer between the first part and the second part.

### CROSS-REFERENCE OF RELATED APPLICATION

This application is a Section 371 National Stage Application of International Application No. PCT/JP2023/030312, filed Aug. 23, 2023, which is incorporated by reference in its entirety and published as WO 2024/043276A1 on Feb. 29, 2024 and which claims priority of Japanese Application No. 2022-134228, filed Aug. 25, 2022.

### BACKGROUND

The present invention relates to a vacuum pump and a stator component.

In a semiconductor manufacturing device, a liquid crystal manufacturing device, an electron microscope, a surface analyzing device, a microfabricated device or the like, an environment in the device needs to be in a highly vacuum state. In order to bring insides of these devices into the highly vacuum state, a vacuum pump is used. Examples of the vacuum pump in use include a complex pump combining a turbo-molecular pump and a thread-groove pump, for example.

In the vacuum pump combining the turbo-molecular pump and the thread-groove pump, as disclosed in Japanese Patent Application Publication No. 2020-197152, for example, the thread-groove pump is disposed on a downstream side of a turbo pump having rotor blades and stator blades aligned alternately in an axial direction. An exhaust gas sucked in through an inlet port is compressed by the turbo-molecular pump and the thread-groove pump and is exhausted to outside of the vacuum pump through an outlet port.

The thread-groove pump is constituted by a rotating rotor cylindrical portion and a thread-groove spacer on a casing side which accommodates a rotor. On an opposed surface of the rotor cylindrical portion or the thread-groove spacer, a thread groove is formed. Thus, by rotation of the rotor cylindrical portion inside the thread-groove spacer, a gas can be transferred to an outlet port side.

The exhaust gas presents a behavior of a molecular flow in the turbo-molecular pump, but in the thread-groove pump and a channel on a downstream therefrom, a behavior of a viscous flow or the like is shown due to a relatively high pressure. Therefore, by-products are deposited easily where a flow of the exhaust gas stagnates in the channel of the thread-groove pump and the downstream thereof. When the by-products are deposited in the channel, such a phenomenon occurs that spots which should not have been contacted are contacted, and damage on the vacuum pump or variation in temperature distribution accompanying a change in heat transfer performances of an internal structure occurs, which could lead to a concern that safety/productivity are impaired.

Therefore, in the vacuum pump, a stator component (thread-groove spacer) on a stator side forming the thread-groove pump in collaboration with a rotor is heated by another member in contact and is held at a predetermined high temperature so that generation of depositions is suppressed.

The discussion above is merely provided for general background information and is not intended to be used as an aid in determining the scope of the claimed subject matter. The claimed subject matter is not limited to implementations that solve any or all disadvantages noted in the background.

### SUMMARY

A stator component which exhausts a sucked-in gas in collaboration with a rotor has a thick portion for the purposes of improving the heat transfer performances in a heat path or promoting heat transfer or the like in some cases. However, when the stator component is formed by casting capable of rapid and inexpensive manufacture, speeds at which metal is solidified are varied between a thick part and a thin part in the stator component, a blowhole or a sink mark (a dent, which is a type of the blowhole) can be generated easily in the stator component.

The present invention was made in order to solve the problem described above and has an object to provide a vacuum pump and a stator component which can suppress generation of a blowhole or a sink mark in a thick part of the stator component formed by casting and can promote heat transfer in the stator component.

The aforementioned object is achieved by the invention described in the following (1).
(1) A vacuum pump according to the present invention is characterized by including a housing, a rotor shaft enclosed in the housing and rotatably supported, a rotor fixed to the rotor shaft and rotated with the rotor shaft, and an annular stator component which exhausts a sucked-in gas in collaboration with the rotor, and the stator component has a first part and a second part at least partially formed by casting and disposed by sandwiching at least one reducing groove reducing a volume and extending along a circumferential direction of the stator component and a bottom portion disposed by containing at least a bottom of the reducing groove and connecting the first part and the second part, and the stator component includes a heat-transfer improving structure which improves heat transfer between the first part and the second part, different from the bottom portion.

The vacuum pump described in the aforementioned (1) can uniformize a speed at which metal at casting is solidified and suppress generation of a blowhole or a sink mark by disposing the reducing groove at the thick part of the stator component formed by casting and can promote heat transfer between the first part and the second part, which could be lowered by providing the reducing groove, by the heat-transfer improving structure.
(2) In the vacuum pump described in the aforementioned (1), the heat-transfer improving structure may be a bridging structure which connects the first part and the second part facing each other with the reducing groove therebetween. As a result, the vacuum pump can effectively promote the heat transfer between the first part and the second part by the bridging structure while maintaining the suppressing effect of generation of the blowhole or the sink mark by the reducing groove.
(3) In the vacuum pump described in the aforementioned (1) or (2), the heat-transfer improving structure may be formed by a material having a heat conductivity higher than that of a material of the cast part of the stator component. As a result, the vacuum pump can effectively promote heat transfer between the first part and the second part.
(4) In the vacuum pump described in any one of the aforementioned (1) to (3), the first part and the second part may be disposed to be aligned with the reducing groove sandwiched in a radial direction from a center of the stator component, which is annular. As a result, since the heat is supplied from an outer side in the radial direction of the stator component, the vacuum pump can effectively transfer the heat to an inner side in the radial direction through the heat-transfer improving structure.
(5) In the vacuum pump described in any one of the aforementioned (1) to (4), the stator component may be a component constituting a thread-groove pump portion. As a result, the vacuum pump can suppress occurrence of depositions by heating a vicinity of the thread groove of the thread-groove pump where deposition of a gas can be generated easily when a temperature is lowered while the stator component remains to be formed of a casting.
(6) In the vacuum pump described in any one of the aforementioned (1) to (5), in the stator component, as the thread-groove pump portion, a spiral-shaped groove portion having a spiral-shaped ridge portion and a spiral-shaped root portion and a thread-shaped groove portion having a thread-shaped ridge portion and a thread-shaped root portion may be formed. As a result, by providing the heat-transfer improving structure in the stator component in the vacuum pump, occurrence of the deposition can be suppressed by heating vicinities of the spiral-shaped groove portion and the thread-shaped groove portion where deposition can be generated easily when a temperature is lowered.
(7) In the vacuum pump described in any one of the aforementioned (1) to (6), the reducing groove may be located on a surface on a side opposite to a surface where the thread-groove pump portion of the stator component is formed. As a result, in the vacuum pump, the heat transfer to the thread-groove pump portion, which is preferable in suppressing depositions, can be effectively maintained while the reducing groove is formed in the vicinity of the thickened thread-groove pump portion of the stator component.
(8) The stator component according to the present invention is a stator component which exhausts a sucked-in gas in collaboration with a rotatable rotor of the vacuum pump, characterized by having a first part and a second part at least partially formed by casting and disposed by sandwiching at least one reducing groove reducing a volume and extending along a circumferential direction of the stator component and a bottom portion which is disposed by containing at least a bottom of the reducing groove and connects the first part and the second part and by including a heat-transfer improving structure which improves heat transfer between the first part and the second part, different from the bottom portion. As a result, the stator component can uniformize a speed at which metal at casting is solidified and suppress generation of a blowhole or a sink mark by disposing the reducing groove at the thick part and can improve the heat transfer between the first part and the second part, which could be lowered by providing the reducing groove, by the heat-transfer improving structure.

The Summary is provided to introduce a selection of concepts in a simplified form that are further described in the Detail Description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a vertical sectional view of a vacuum pump;

FIG. 2 is a circuit diagram of an amplifier circuit;

FIG. 3 is a time chart illustrating control when a current instruction value is larger than a detected value;

FIG. 4 is a time chart illustrating control when a current instruction value is smaller than a detected value;

FIG. 5 is a vertical sectional view of the vacuum pump according to this embodiment;

FIG. 6A and FIG. 6B are sectional views illustrating a thread-groove spacer in a partially enlarged manner, in which FIG. 6A is an enlarged sectional view of a range indicated by A in FIG. 5, and FIG. 6B is an enlarged sectional view in a phase different from that in FIG. 6A;

FIG. 7 is a perspective view illustrating the thread-groove spacer;

FIG. 8 is a plan view of the thread-groove spacer when seen from an upstream side;

FIG. 9 is a plan view of the thread-groove spacer when seen from a downstream side;

FIG. 10 is a sectional view along a B-B line in FIG. 8; and

FIG. 11 is a vertical sectional view illustrating a part of the vacuum pump according to a variation.

### DESCRIPTION OF THE PREFERRED EMBODIMENTS

Hereinafter, an embodiment of the present invention will be described by referring to the drawings. Dimensions in the drawings are exaggerated for convenience of the description and may be different from actual dimensions in some cases. Moreover, constituent elements having substantially the same functional configurations in the specification and the drawings are given the same reference signs, and duplicated explanation will be omitted.

A vacuum pump 100 according to the embodiment of the present invention is a turbo-molecular pump 100 which exhausts a gas by flipping off gas molecules by a rotor blade of a rotating body rotated at a high speed. The turbo-molecular pump 100 is used for sucking a gas from a chamber of a semiconductor manufacturing device or the like, for example, and exhausting it. First, a basic configuration of the turbo-molecular pump 100 will be described.

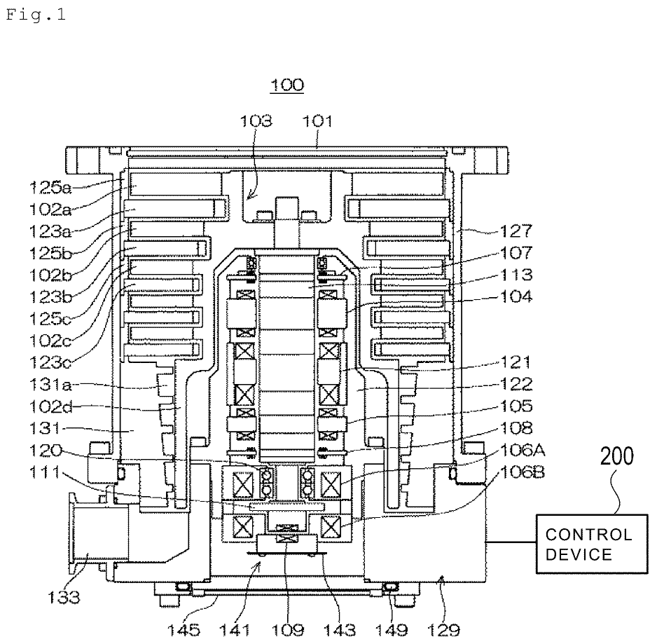

A vertical sectional view of this turbo-molecular pump 100 is shown in FIG. 1. In FIG. 1, the turbo-molecular pump 100 has an inlet port 101 formed on an upper end of a cylindrical outer cylinder 127. And inward of the outer cylinder 127, a rotor 103 having a plurality of rotor blades 102 (102a, 102b, 102c, . . . ) , which are turbine blades for sucking/exhausting the gas, formed radially and in multiple stages on a circumferential part is provided. At a center of this rotor 103, a rotor shaft 113 is mounted, and this rotor shaft 113 is floated/supported and position-controlled by a magnetic bearing of five-axes control, for example. The rotor 103 is constituted by metal such as aluminum or an aluminum alloy in general.

Regarding upper-side radial electromagnets 104, four electromagnets are disposed in pairs on an X-axis and a Y-axis. Close to the upper-side radial electromagnets 104 and corresponding to each of f the upper-side radial electromagnets 104, four upper-side radial sensors 107 are provided. For the upper-side radial sensor 107, an inductance sensor, an eddy current sensor or the like having a conductive winding is used, for example, and a position of the rotor shaft 113 is detected on the basis of a change in inductance of this conductive winding changing in accordance with the position of the rotor shaft 113. The upper-side radial sensor 107 is configured to detect radial displacement of the rotor shaft 113, that is, of the rotor 103 fixed thereto and to send the detected result to a control device 200.

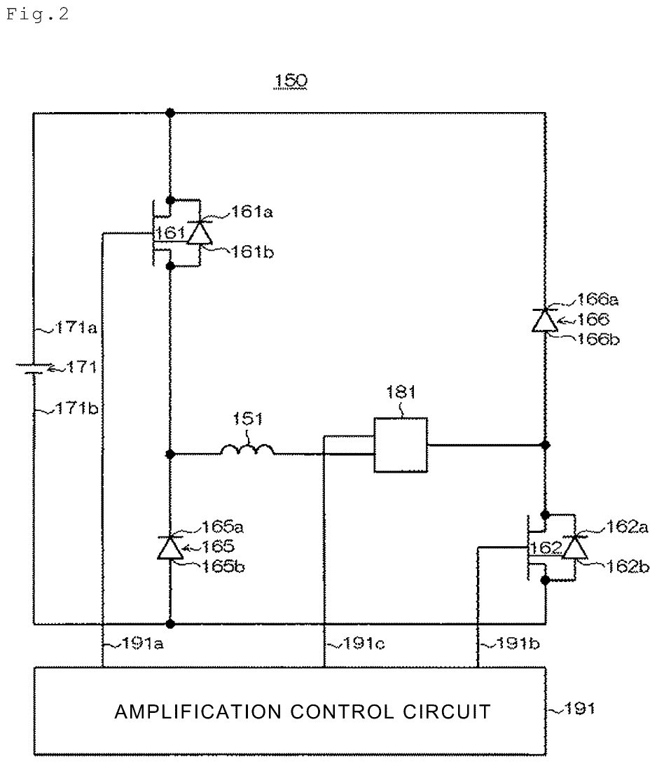

In this control device 200, a compensation circuit having a PID adjustment function, for example, generates an excitation control instruction signal of the upper-side radial electromagnet 104 on the basis of a position signal detected by the upper-side radial sensor 107, and an amplification circuit 150 (which will be described later) shown in FIG. 2 excites/controls the upper-side radial electromagnet 104 on the basis of this excitation control instruction signal so that a radial position on an upper side of the rotor shaft 113 is adjusted.

And this rotor shaft 113 is formed of a material with high magnetic permeability (iron, stainless or the like) or the like and is configured to be attracted by a magnetic force of the upper-side radial electromagnet 104. Such adjustment is made independently in an X-axis direction and in a Y-axis direction, respectively. Moreover, a lower-side radial electromagnet 105 and a lower-side radial sensor 108 are disposed similarly to the upper-side radial electromagnet 104 and the upper-side radial sensor 107, and a radial position on a lower side of the rotor shaft 113 is adjusted similarly to the radial position on the upper side.

Furthermore, axial electromagnets 106A and 106B are disposed by vertically sandwiching a disc-shaped metal disc 111 provided on a lower part of the rotor shaft 113. The metal disc 111 is constituted by a material with high magnetic permeability such as iron. An axial sensor 109 is provided in order to detect axial displacement of the rotor shaft 113, and it is configured such that an axial position signal thereof is sent to the control device 200.

And in the control device 200, the compensation circuit having the PID adjustment function, for example, generates the excitation control instruction signal for each of the axial electromagnet 106A and the axial electromagnet 106B on the basis of an axial position signal detected by the axial sensor 109, and the amplification circuit 150 excites/controls the axial electromagnet 106A and the axial electromagnet 106B on the basis of the excitation control instruction signals, respectively, so that the axial electromagnet 106A attracts the metal disc 111 upward by the magnetic force, while the axial electromagnet 106B attracts the metal disc 111 downward, and the axial position of the rotor shaft 113 is adjusted.

As described above, the control device 200 appropriately adjusts the magnetic force by the axial electromagnets 106A and 106B applied to the metal disc 111, magnetically floats the rotor shaft 113 in the axial direction and holds the rotor shaft 113 in a space in a non-contact manner. Note that the amplification circuit 150 which excites/controls the upper-side radial electromagnet 104, the lower-side radial electromagnet 105, and the axial electromagnets 106A and 106B will be described later.

On the other hand, a motor 121 includes a plurality of magnetic poles disposed in a circumferential state so as to surround the rotor shaft 113. Each of the magnetic poles is controlled by the control device 200 so as to rotate/drive the rotor shaft 113 through an electromagnetic force acting between it and the rotor shaft 113. Moreover, the motor 121 incorporates rotational speed sensors such as a Hall element, a resolver, an encoder and the like, not shown, for example, and it is configured such that a rotational speed of the rotor shaft 113 is detected by a detection signal of this rotational speed sensor.

Furthermore, in the vicinity of the lower-side radial sensor 108, for example, a phase sensor, not shown, is mounted so as to detect a phase of rotation of the rotor shaft 113. The control device 200 is configured to detect a position of the magnetic pole by using detection signals of both the phase sensor and the rotational speed sensor.

With a slight clearance from the rotor blades 102 (102a, 102b, 102c, . . . ) , a plurality of stator blades 123 (123a, 123b, 123c, . . . ) are disposed. Each of the rotor blades 102 (102a, 102b, 102c, . . . ) is formed with inclination by a predetermined angle from a plane perpendicular to an axis of the rotor shaft 113 so as to transfer molecules of an exhaust gas to a lower direction by a collision, respectively. The stator blades 123 (123a, 123b, 123c, . . . ) are constituted by metal such as aluminum, iron, stainless, copper and the like or an alloy containing these metals as components, for example.

Moreover, the stator blades 123 are also formed similarly with inclination by a predetermined angle from the plane perpendicular to the axis of the rotor shaft 113 and are disposed alternately with stages of the rotor blades 102 toward an inside of the outer cylinder 127. And outer peripheral ends of the stator blades 123 are supported in a state fitted and inserted between stator-blade spacers 125 (125a, 125b, 125c, . . . ) stacked in plural stages.

The stator-blade spacer 125 is a ring-shaped member and is constituted by metal such as aluminum, iron, stainless, copper or the like or an alloy containing these metals as components, for example. On an outer periphery of the stator-blade spacer 125, the outer cylinder 127 is fixed with a slight clearance. On a bottom part of the outer cylinder 127, a base portion 129 is disposed. On the base portion 129, an outlet port 133 is formed and is made to communicate with the outside. An exhaust gas entering from a chamber (vacuum chamber) side into the inlet port 101 and transferred to the base portion 129 is sent to the outlet port 133.

Moreover, depending on an application the turbo-molecular pump 100, a thread-groove spacer 131 (stator member) is disposed between a lower part of the stator-blade spacer 125 and the base portion 129. The thread-groove spacer 131 is a cylindrical member constituted by metal such as aluminum, copper, stainless, iron or an alloy having these metals as components, and plural streaks of spiral thread grooves 131a are engraved in an inner peripheral surface thereof. A spiral direction of the thread groove 131a is a direction in which, when a molecule of the exhaust gas is moved in a rotating direction of the rotor 103, the molecule is transferred toward the outlet port 133. A cylinder portion 102d is suspended at a lowest part continuing to the rotor blade 102 (102a, 102b, 102c . . . ) of the rotor 103. An outer peripheral surface of this cylinder portion 102d has a cylindrical shape, extends toward the inner peripheral surface of the thread-groove spacer 131 and is close to the inner peripheral surface of this thread-groove spacer 131 with a predetermined gap amount therefrom. The exhaust gas having been transferred by the rotor blade 102 and the stator blade 123 to the thread groove 131a is sent to the base portion 129 while being guided by the thread groove 131a.

The base portion 129 is a disc-shaped member constituting a base bottom portion of the turbo-molecular pump 100 and is constituted by metal such as iron, aluminum, stainless or the like in general. The base portion 129 physically holds the turbo-molecular pump 100 and has a function of a conducting path of a heat at the same time and thus, metal with rigidity and high heat conductivity such as iron, aluminum, copper or the like is preferably used.

In such configuration, when the rotor blade 102 is rotated/driven together with the rotor shaft 113 by the motor 121, by means of actions of the rotor blade 102 and the stator blade 123, the exhaust gas is sucked from the chamber through the inlet port 101. A rotational speed of the rotor blade 102 is usually 20000 rpm to 90000 rpm, and a peripheral speed at a distal end of the rotor blade 102 reaches 200 m/s to 400 m/s. The exhaust gas sucked through the inlet port 101 passes between the rotor blade 102 and the stator blade 123 and is transferred to the base portion 129. At this time, a temperature of the rotor blade 102 is raised by a friction heat generated when the exhaust gas contacts the rotor blade 102 or conduction or the like of a heat generated in the motor 121, but this heat is conducted to the stator blade 123 side by radiation or conduction by a gas molecule or the like of the exhaust gas.

The stator-blade spacers 125 are joined to each other on outer peripheral portions and conduct a heat that the stator blade 123 received from the rotor blade 102, the friction heat generated when the exhaust gas contacts the stator blade 123 and the like to the outside.

Note that such explanation was made in the above that the thread-groove spacer 131 is disposed on the outer periphery of the cylinder portion 102d of the rotor 103, and the thread groove 131a is engraved in the inner peripheral surface of the thread-groove spacer 131. However, to the contrary, the thread groove is engraved in the outer peripheral surface of the cylinder portion 102d, and a spacer having a cylindrical inner peripheral surface is disposed in the periphery thereof in some cases.

Moreover, depending on the application of the turbo-molecular pump 100, a periphery of an electric component portion is covered with a stator column 122 so that the gas sucked through the inlet port 101 does not intrude into the electric component portion constituted by the upper-side radial electromagnet 104, the upper-side radial sensor 107, the motor 121, the lower-side radial electromagnet 105, the lower-side radial sensor 108, the axial electromagnets 106A and 106B, the axial sensor 109 and the like, and an inside of this stator column 122 is held at a predetermined pressure by a purge gas in some cases.

In this case, piping, not shown, is disposed in the base portion 129, and the purge gas is introduced through this piping. The introduced purge gas is sent out to the outlet port 133 through clearances between a protective bearing 120 and the rotor shaft 113, between a rotor of the motor 121 and a stator, and between the stator column 122 and the inner-peripheral side cylinder portion of the rotor blade 102.

Here, the turbo-molecular pump 100 needs control based on specification of a model and individually adjusted specific parameters (characteristics corresponding to the model, for example). In order to store the control parameters, the turbo-molecular pump 100 includes an electronic circuit portion 141 in a main body thereof. The electronic circuit portion 141 is constituted by electronic components such as a semiconductor memory such as an EEP-ROM and the like, a semiconductor device and the like for access thereof, a substrate 143 for mounting them and the like. This electronic circuit portion 141 is accommodated in a lower part of a rotational speed sensor, not shown, close to a center, for example, of the base portion 129 constituting the lower part of the turbo-molecular pump 100 and is closed by an airtight bottom lid 145.

In a manufacturing process of a semiconductor, some process gases introduced into a chamber have a characteristic that the gas becomes solid when a pressure thereof becomes higher than a predetermined value or when a temperature thereof becomes lower than a predetermined value. Inside the turbo-molecular pump 100, the pressure of the exhaust gas is the lowest at the inlet port 101 and the highest at the outlet port 133. If the pressure of the process gas becomes higher than the predetermined value, or the temperature thereof becomes lower than the predetermined value in the middle of transfer from the inlet port 101 to the outlet port 133, the process gas becomes a solid state and adheres to and deposits on the inside of the turbo-molecular pump 100.

For example, if SiCl₄ is used as a process gas in an Al etching device, it is known from a steam-pressure curve that a solid product (AlCl₃, for example) is precipitated at a low vacuum (760 [torr] to 10-2 [torr] ) and at a low temperature (approximately 20 [° C.]) and adheres/deposits inside the turbo-molecular pump 100. As a result, if the precipitates of the process gas deposit inside the turbo-molecular pump 100, the deposits narrow a pump channel and cause deterioration of performances of the turbo-molecular pump 100. Then, there was such a state that the aforementioned products easily solidify or adhere in a portion close to the outlet port 133 or close to the thread-groove spacer 131 with a high pressure.

Thus, in order to solve this problem, conventionally, a heater, not shown, or an annular water-cooling pipe 149 is wound around an outer periphery of the base portion 129 or the like, and a temperature sensor (a thermistor, for example), not shown, is embedded in the base portion 129, for example, and heating of the heater or cooling by the water-cooling pipe 149 is controlled (hereinafter, referred to as TMS. TMS: Temperature Management System) so that the temperature of the base portion 129 is kept at a certain high temperature (set temperature) on the basis of a signal of this temperature sensor.

Subsequently, regarding the turbo-molecular pump 100 constituted as above, the amplification circuit 150 which excites/controls the upper-side radial electromagnet 104, the lower-side radial electromagnet 105, and the axial electromagnets 106A and 106B thereof will be described. A circuit diagram of this amplification circuit 150 is shown in FIG. 2.

In FIG. 2, an electromagnet winding 151 constituting the upper-side radial electromagnet 104 and the like has one end thereof connected to a positive electrode 171a of a power source 171 through a transistor 161 and has the other end connected to a negative electrode 171b of the power source 171 through a current detection circuit 181 and a transistor 162. And the transistors 161 and 162 are so-called power MOSFET and have a structure in which a diode is connected between a source and a drain thereof.

At this time, the transistor 161 has a cathode terminal 161a of the diode thereof connected to the positive electrode 171a and has an anode terminal 161b connected to one end of the electromagnet winding 151. Moreover, the transistor 162 has a cathode terminal 162a of the diode thereof connected to the current detection circuit 181 and has an anode terminal 162b connected to the negative electrode 171b.

On the other hand, a diode 165 for current regeneration has a cathode terminal 165a thereof connected to one end of the electromagnet winding 151 and has an anode terminal 165b thereof connected to the negative electrode 171b. Moreover, similarly to this, a diode 166 for current regeneration has a cathode terminal 166a thereof connected to the positive electrode 171a and an anode terminal 166b thereof connected to the other end of the electromagnet winding 151 through the current detection circuit 181. And the current detection circuit 181 is constituted by a Hall-sensor type current sensor or an electric resistance element, for example.

The amplification circuit 150 constituted as above corresponds to one electromagnet. Thus, in a case where the magnetic bearing is five-axis control and has 10 pieces of the electromagnets 104, 105, 106A and 106B in total, the similar amplification circuit 150 is constituted for each of the electromagnets, and 10 units of the amplification circuits 150 are connected in parallel to the power source 171.

Moreover, an amplification control circuit 191 is constituted by a digital signal processor portion (hereinafter, referred to as a DSP portion), not shown, of the control device 200, for example, and this amplification control circuit 191 is configured to switch on/off the transistors 161 and 162.

The amplification control circuit 191 is configured to compare a current value (a signal reflecting this current value is referred to as a current detection signal 191c) detected by the current detection circuit 181 and a predetermined current instructed value. And on the basis of this comparison result, a size of a pulse width (pulse-width time Tp1, Tp2) to be generated in a control cycle Ts, which is one cycle by PWM control, is determined. As a result, gate drive signals 191a and 191b having this pulse width are configured to be output to gate terminals of the transistors 161 and 162 from the amplification control circuit 191.

Note that it is necessary to execute position control of the rotor 103 at a high speed and with a strong force when passing a resonant point during an acceleration operation of a rotational speed of the rotor 103 or at occurrence of a disturbance during a constant-speed operation and the like. Thus, a high voltage such as approximately 50V, for example, is used in the power source 171 so that the current flowing through the electromagnet winding 151 can be rapidly increased (or decreased). Moreover, a capacitor is usually connected between the positive electrode 171a and the negative electrode 171b of the power source 171 for stabilization of the power source 171 (not shown).

In the configuration as above, when both the transistors 161 and 162 are turned on, the current flowing through the electromagnet winding 151 (hereinafter referred to as an electromagnet current iL) increases, while when both the transistors 161 and 162 are turned off, the electromagnet current iL decreases.

Moreover, when one of the transistors 161 and 162 is turned on, while the other is turned off, a so-called flywheel current is held. And by causing the flywheel current to flow through the amplification circuit 150 as above, a hysteresis loss in the amplification circuit 150 is decreased, and power consumption as the entire circuit can be kept low. Moreover, by controlling the transistors 161 and 162 as above, a high-frequency noise such as a harmonic or the like generated in the turbo-molecular pump 100 can be reduced. Furthermore, by measuring this flywheel current by the current detection circuit 181, the electromagnet current iL flowing through the electromagnet winding 151 can be detected.

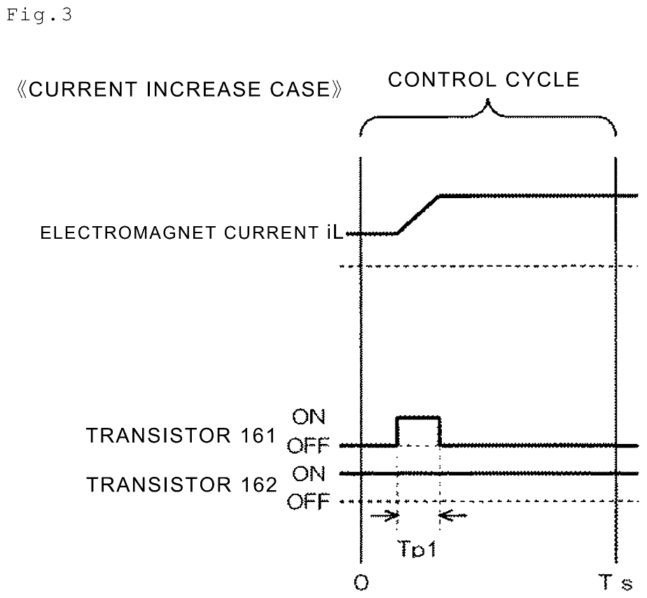

That is, if the detected current value is smaller than the current instructed value, the transistors 161 and 162 are both turned on only for a period of time corresponding to the pulse-width time Tp1 only once in a control cycle Ts (100 μs, for example) as shown in FIG. 3. Thus, the electromagnet current iL during this period increases toward a current value iLmax (not shown) that can be made to flow from the positive electrode 171a to the negative electrode 171b through the transistors 161 and 162.

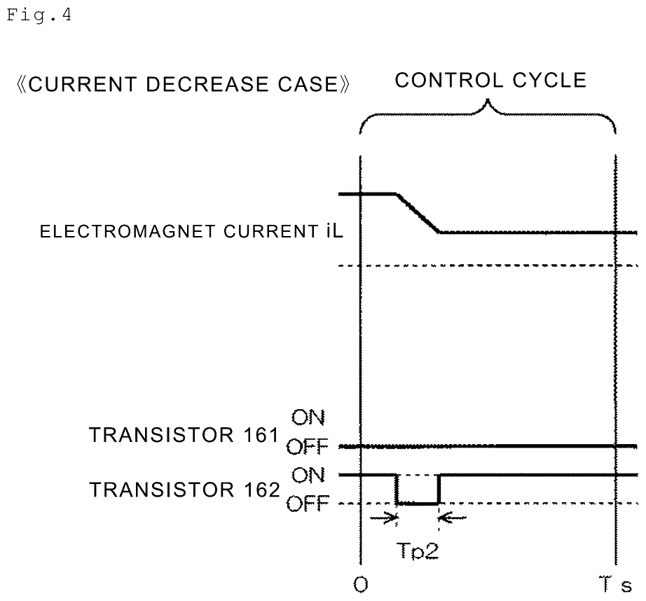

On the other hand, if the detected current value is larger than the current instructed value, the transistors 161 and 162 are both turned off only for a period of time corresponding to the pulse-width time Tp2 only once in the control cycle Ts as shown in FIG. 4. Thus, the electromagnet current iL during this period decreases toward a current value iLmin (not shown) that can be regenerated from the negative electrode 171b to the positive electrode 171a through the diodes 165 and 166.

And in any case, after elapse of the pulse-width time Tp1, Tp2, either one of the transistors 161 and 162 is turned on. Thus, the flywheel current is held in the amplification circuit 150 during this period.

### This Embodiment

Subsequently, a vacuum pump 210 according to this embodiment will be described.

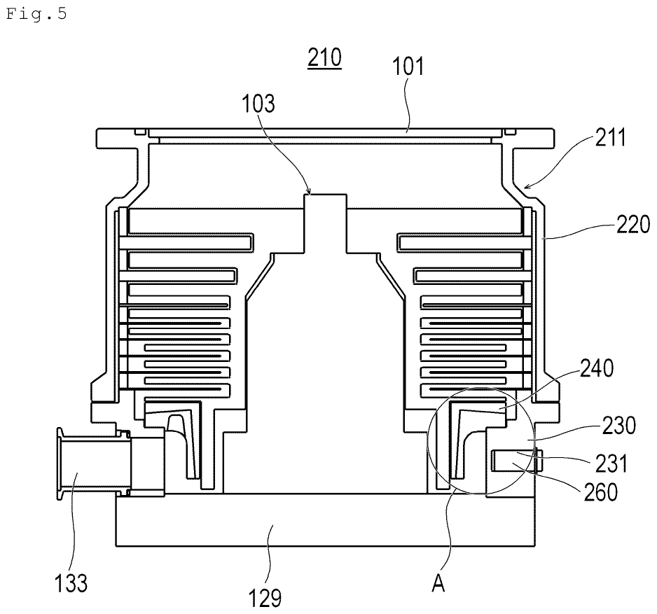

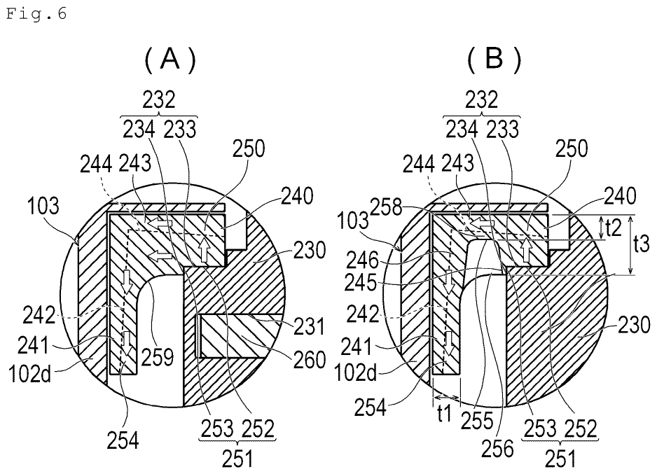

In the vacuum pump 210, as shown in FIG. 5, FIG. 6A, and FIG. 6B, a casing 211 (housing) forming an outer shell of the vacuum pump 210 is constituted by a plurality of components. Specifically, the casing 211 includes an upper case 220 in which the inlet port 101 is disposed, a lower case 230 in which the outlet port 133 is disposed, and the base portion 129. The casing 211 forms a substantially cylindrical shape with the base portion 129 as a bottom, and a thread-groove spacer 240 (stator component) is installed in an internal space thereof. The upper case 220, the lower case 230, and the thread-groove spacer 240 are disposed coaxially and integrally coupled by a fastening member such as a bolt.

The lower case 230 is formed having a cylindrical shape and has a plurality of installation holes 231 formed in an outer peripheral surface, and heating means 260 is inserted into each of the installation holes 231. In the lower case 230, a heating-side contact surface 232 brought into contact with a part of the thread-groove spacer 240 is formed on a part of a surface on the upstream side and an inner peripheral surface. The heating-side contact surface 232 is formed having a ring shape when seen from the upstream side. The heating-side contact surface 232 includes a heating-side upper contact surface 233 formed on the surface on the upstream side of the lower case 230 and a heating-side inner contact surface 234 formed on the inner peripheral surface of the lower case 230. The heating-side upper contact surface 233 and the heating-side inner contact surface 234 are connected with a step therebetween. The lower case 230 heated by the heating means 260 can heat the thread-groove spacer 131 by the heating-side contact surface 232.

The installation holes 231 are preferably disposed uniformly along a circumferential direction, but do not have to be disposed uniformly. The number of the installation holes 231 only needs to be one or more and is not particularly limited. The heating means 260 is not particularly limited but it is a cartridge heater in which a heat generating body is disposed inside a metal pipe, and both terminals to be connected to the heat generating body are disposed on one end side of the metal pipe.

The upper case 220 and the lower case 230 need to play a role as the casing 211 which maintains vacuum and thus, materials of the upper case 220 and the lower case 230 cannot be determined by considering only the heat conductivity but are selected also by considering material strength at a temperature during an operation. The upper case 220 and the lower case 230 are formed of stainless steel, for example, in which lowering of a proof stress at a high temperature is smaller than aluminum, and deformation caused by a heat hardly occurs.

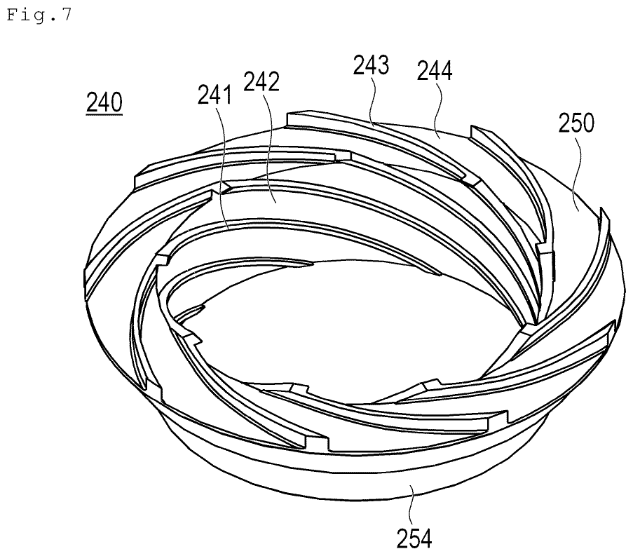

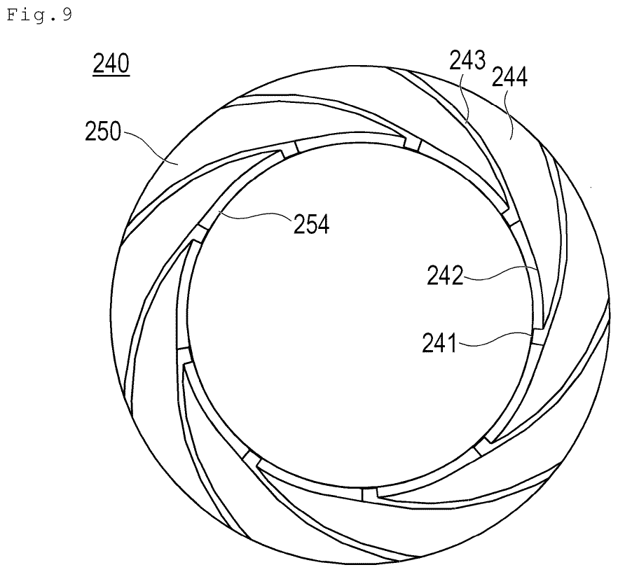

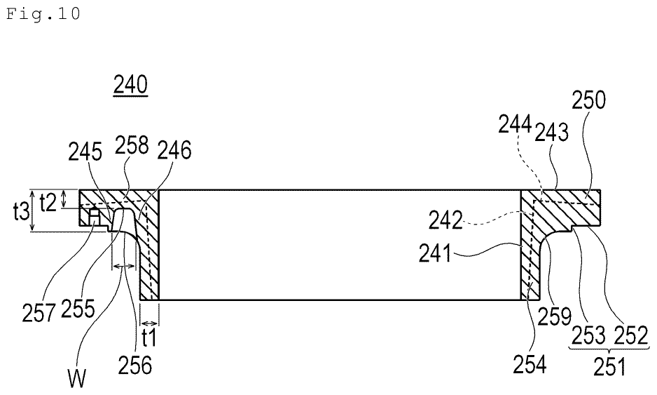

The thread-groove spacer 240 is, as shown in FIG. 5 to FIG. 10, an annular component which exhausts sucked-in gas in collaboration with the rotor 103. The thread-groove spacer 240 is formed of a material with a high heat transfer performance in order to transfer the heat transmitted from the lower case 230 to the thread-groove pump portion functioning in collaboration with the rotor 103. The material of the thread-groove spacer 240 has heat conductivity higher than that of the material of the lower case 230. The material of the thread-groove spacer 240 is preferably a castable aluminum alloy (ADC12, for example). In this embodiment, the thread-groove spacer 131 is formed by casting (die-cast, for example) with an aluminum alloy as a material. A part of the thread-groove spacer 131 may be subjected to additional machining such as cutting, coating and the like after the casting. Since the thread-groove spacer formed by casting, it can be manufactured rapidly and inexpensively.

In the thread-groove spacer 240, a part of a Holweck-type thread-groove pump including a thread-shaped ridge portion 241 and a thread-shaped root portion 242 which move in the axial direction while rotating around the shaft is formed and a part of a Siegbahn-type thread-groove pump including a spiral-shaped ridge portion 243 and a spiral-shaped root portion 244 is formed so that the spiral-shaped ridge portion 243 and the spiral-shaped root portion 244 are separated away from (or get closer to) the shaft, while rotating in the same plane around the shaft.

The thread-groove spacer 240 includes an annular coupling portion 250 including a heated-side contact surface 251 coupled in contact with the heating-side contact surface 232 of the lower case 230 and a cylindrical extended portion 254 extending toward the downstream from an inner-peripheral surface side of the coupling portion 250. In the thread-groove spacer 131, the spiral-shaped ridge portion 243 and the spiral-shaped root portion 244 are formed on a surface on the upstream side of the coupling portion 250, and the thread-shaped ridge portion 241 and the thread-shaped root portion 242 are formed on an inner peripheral surface of the extended portion 254. The heated-side contact surface 251 includes a heated-side lower contact surface 252 in contact with the heating-side upper contact surface 233 of the lower case 230 and a heated-side outer contact surface 253 in contact with the heating-side inner contact surface 234 of the lower case 230. The heated-side lower contact surface 252 is formed on a surface directed to the downstream side of the coupling portion 250, and the heated-side outer contact surface 253 is formed on a surface on an inner side in a radial direction of the heated-side lower contact surface 252 and directed to the outer side in the radial direction. The heated-side lower contact surface 252 and the heated-side outer contact surface 253 are connected with a step therebetween. The thread-groove spacer 131 is heated from the heating-side contact surface 232 of the lower case 230 heated by the heating means 260 through the heated-side contact surface 251.

In the coupling portion 250, a plurality of reducing grooves 255 and a plurality of heat-transfer improving structures 256 aligned in a circumferential direction are formed on an inner side in the radial direction of the heated-side contact surface 251. The plurality of reducing grooves 255 and the plurality of heat-transfer improving structure 256 are disposed alternately in the circumferential direction.

The reducing groove 255 is a portion which partially reduces a thickness of the thread-groove spacer 240 and is formed on a surface (surface on the downstream side) on a side opposite to a surface (surface on the upstream side) on which the spiral-shaped ridge portion 243 and the spiral-shaped root portion 244 constituting the thread-groove pump portion are formed, toward the upstream side. The reducing groove 255 is formed with a depth not penetrating the coupling portion 250. In the coupling portion 250, a bottom portion 258 whose thickness is reduced by forming the reducing groove 255 is formed on the bottom of each of the reducing grooves 255. It is preferable that the reducing groove 255 is not disposed on the heated-side contact surface 251. As a result, in the thread-groove spacer 131, the heated-side contact surface 251 receiving a heat can be sufficiently ensured, and a decrease of heat transfer from the lower case 230 due to a decrease of the heated-side contact surface 251 can be prevented. A width W (length in the radial direction) of the reducing groove 255 is gradually decreased toward a depth direction. As a result, a release performance of the thread-groove spacer 131 at casting can be improved, and a flow of a material at the casting can be made smooth.

Each of the heat-transfer improving structures 256 is disposed in a portion between two pieces of the reducing grooves 255 adjacent in the circumferential direction, where the reducing groove 255 is not formed. The thread-groove spacer 240 includes a first part 246 on an inner side in the radial direction of the reducing groove 255 and a second part 245 on an outer side in the radial direction of the reducing groove 255, and the first part 246 and the second part 245 face each other with a plurality of the reducing grooves 255 therebetween. And the first part 246 and the second part 245 are coupled by the plurality of heat-transfer improving structures 256. That is, the heat-transfer improving structure 256 is a bridging structure connecting the first part 246 and the second part 245 that face to each other with the reducing groove 255 therebetween. In the thread-groove spacer 240, the heat transmitted from the lower case 230 to the heated-side contact surface 251 moves from the second part 245 toward the first part 246. A smooth recess-shaped curved portion 259 is formed on a surface of a connection part between the heat-transfer improving structure 256 and the first part 246. As a result, the flow of the material at the casting can be made smooth, and stress concentration between the thick part having the heat-transfer improving structure 256 and the thin extended portion 254 can be suppressed. Therefore, a blowhole or a sink mark does not occur easily anymore in the thread-groove spacer 240, which is a casting, and breakage caused by stress concentration can be reduced.

By the way, in order to have the thread-groove spacer 131 as the casting, a material to be used needs to be changed to a material suitable for casting (change of an aluminum alloy A5056 to ADC12, for example), which might cause the heat conductivity to be lowered. On the other hand, since the thread-groove spacer 131 includes the heat-transfer improving structure 256, high heat-transfer performances can be obtained even if the heat conductivity is lowered due to the change of the material.

The number of each of the reducing grooves 255 and the heat-transfer improving structures 256 is not particularly limited, but they are preferably provided in plural, and ten pieces of each are provided in this embodiment.

Moreover, in the heated-side lower contact surface 252 of the coupling portion 250, a plurality of bolt holes 257 aligned in the circumferential direction are formed. With the bolt hole 257, a bolt inserted from the lower case 230 side is screwed. A phase (position in the circumferential direction) of the bolt hole 257 is preferably overlapped with the phase of the reducing groove 255 so as not to overlap the phase of the heat-transfer improving structure 256. As a result, the heat-transfer performances of the heat-transfer improving structure 256 can be prevented from being lowered by the bolt hole 257.

A thickness t2 in an axial direction of the bottom portion 258 in which the reducing groove 255 of the coupling portion 250 is formed is smaller than a thickness t3 in the axial direction of the second part 245 of the coupling portion 250. Moreover, a thickness t1 in the radial direction of the cylindrical extended portion 254 is smaller than the thickness t3 in the axial direction of the second part 245 of the coupling portion 250. Furthermore, a thickness t4 in the circumferential direction of the heat-transfer improving structure 256 is smaller than the thickness t3 in the axial direction of the second part 245 of the coupling portion 250. And the thickness t2 of the bottom portion 258, the thickness t1 of the extended portion 254, and the thickness t4 of the heat-transfer improving structure 256 are substantially the same, be it more or less.

Subsequently, an action of the vacuum pump 210 according to this embodiment will be described.

In this embodiment, the thread-groove spacer 240 is formed by casting (die-cast, for example) with the aluminum alloy as a material. In the casting, if a speed at which metal is solidified is varied, a blowhole or a sink mark (a dent, which is a type of the blowhole) can be easily generated inside the casting. In the thread-groove spacer 240, which is the casting, the thickness t3 in the axial direction of the second part 245 of the annular coupling portion 250 is outstandingly larger than the thickness t1 in the radial direction of the cylindrical extended portion 254 and thus, if there is no reducing groove 255 in the coupling portion 250, the speeds at which the metal is solidified in the coupling portion 250 and the extended portion 254 are largely varied. However, in this embodiment, since the reducing groove 255 which reduces the volume is formed in the coupling portion 250, the thickness t2 of the bottom portion 258, the thickness t1 of the extended portion 254, and the thickness t4 of the heat-transfer improving structure 256 are substantially the same. As a result, the variation in the speed at which the metal in the thread-groove spacer 240 is solidified is reduced, and the blowhole or the sink mark does not occur easily in the thread-groove spacer 240.

Since the thread-groove spacer 240 includes the reducing groove 255, as shown in FIG. 6B, due to necessity that the heat path passes through the bottom portion 258, thermal resistance is increased by elongation of the heat path or a decrease in a sectional area of the heat path, and there is a possibility that the heat-transfer performance is lowered with the increased thermal resistance. However, as shown in FIG. 6A, the thread-groove spacer 240 includes the heat-transfer improving structure 256 which improves the heat transfer between the first part 246 and the second part 245, other than the bottom portion 258. Due to this, the heat transmitted from the lower case 230 can be effectively transferred to the extended portion 254. Thus, the thread-groove spacer 240 can transfer the heat transmitted from the heating-side contact surface 232 of the lower case 230 to the heated-side contact surface 251 effectively to the spiral-shaped ridge portion 243 and the spiral-shaped root portion 244 formed on the surface on the upstream side of the coupling portion 250 and the thread-shaped ridge portion 241 and the thread-shaped root portion 242 formed on the inner peripheral surface of the extended portion 254. Therefore, deposition of a gas in the thread-groove pump caused by lowering of the temperature can be suppressed. As an example, an entire temperature of the thread-groove spacer 240 is preferably controlled to be 100° C. or more.

And since the thread-groove spacer 240 includes the reducing groove 255 and the heat-transfer improving structure 256, even if the thread-groove spacer 240 is casting, a blowhole or a sink mark generated by variation in the speed of solidification caused by an influence of the thickness or the like can be prevented, and the thickness t3 in the axial direction of the second part 245 of the coupling portion 250 can be made large. Therefore, the heat path from the heating means 260 disposed in the lower case 230 to the surface on the upstream side of the thread-groove spacer 240 and the thread groove in the inner peripheral surface of the extended portion 254 can be made shorter. Therefore, the heat-transfer performances of the thread-groove spacer 240 can be improved. Moreover, since the thread-groove spacer 240 has a thick part in the axial direction, a sectional area of the heat path from the heated-side contact surface 251 to the inner peripheral surface of the extended portion 254 is increased, the thermal resistance is decreased with that, and heat transfer from the heated-side contact surface 251 to the thread-shaped ridge portion 241 and the thread-shaped root portion 242 formed on the inner peripheral surface of the extended portion 254 can be promoted. Therefore, it becomes easier to cause the thread-groove spacer 240 to reach a target temperature. Moreover, since the volume of the part formed by a material with high heat conductivity (material of the thread-groove spacer 240) is increased, a heat capacity of the thread-groove spacer 240 becomes larger, whereby the temperature can be made uniform, and the temperature can be made stable at a desirable temperature. Furthermore, since a blowhole or a sink mark is hardly generated in the thread-groove spacer 240, which is the casting, lowering of the heat-transfer performance can be suppressed, and generation of a part where strength is lowered is suppressed, whereby breakage at manufacture or in use can be suppressed.

As described above, the vacuum pump 210 according to this embodiment includes the casing 211 (housing), the rotor shaft 113 enclosed in the housing and rotatably supported, the rotor 103 fixed to the rotor shaft 113 and rotated with the rotor shaft 113, and the annular stator component (thread-groove spacer 240) which exhausts a sucked-in gas in collaboration with the rotor 103, the stator component is formed by casting and has the first part 246 and the second part 245 disposed by sandwiching at least one reducing groove 255 reducing a volume and extending along a circumferential direction of the stator component, and the bottom portion 258 disposed by including at least the bottom of the reducing groove 255 and connecting the first part 246 and the second part 245, and the stator component includes the heat-transfer improving structure 256 which improves the heat transfer between the first part 246 and the second part 245, which are different from the bottom portion 258. As a result, in the vacuum pump 210, by disposing the reducing groove 255 at a thick part of the stator component (thread-groove spacer 240) formed by casting, the speed at which the metal is solidified at casting is uniformized, generation of a blowhole or a sink mark can be suppressed, and the heat transfer between the first part 246 and the second part 245, which could be lowered by providing the reducing groove 255, can be promoted by the heat-transfer improving structure 256.

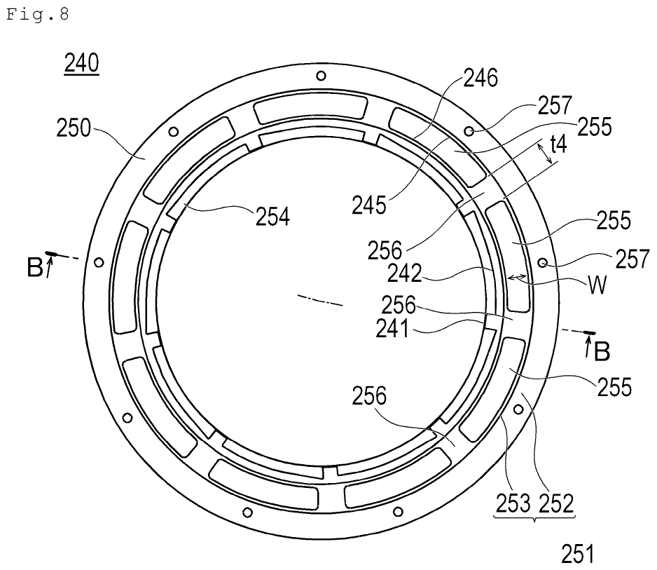

The heat-transfer improving structure 256 is a bridging structure connecting the first part 246 and the second part 245 that face each other with the reducing groove 255 therebetween. As a result, the vacuum pump 210 can effectively promote the heat transfer between the first part 246 and the second part 245 by the bridging structure, while the effect of suppressing generation of a blowhole or a sink mark by the reducing groove 255 is maintained. The bridging structure in this specification is, as shown in FIG. 6A, FIG. 6B, and FIG. 8, defined to include also a structure of connecting the first part 246 and the second part 245 as a part where the reducing groove 255 is not formed with an integral structure such as a wall extending in the axial direction from the bottom portion 258.

The first part 246 and the second part 245 are disposed by being aligned in the radial direction from the center of the stator component, which is annular, with the reducing groove 255 sandwiched. As a result, the vacuum pump 210 can effectively transfer the heat to the inner side in the radial direction through the heat-transfer improving structure 256 by supply of the heat from the outer side in the radial direction of the stator component. Moreover, the vacuum pump 210 can promote not only the heat transfer from the heating means 260 to the inner side in the radial direction in which the thread-groove pump of the stator component (thread-groove spacer 240) is located but also the heat transfer to the outer side in the radial direction to the contrary. For example, in order to lower the temperature of the rotor 103 for the purpose of increasing an allowable flowrate of the gas (related to a heat-resisting temperature or the like of the material of the rotor 103), the vacuum pump 210 may include an effect of actively causing the heat to escape to the outside through the stator component.

The stator component may be a component constituting the thread-groove pump portion. As a result, the vacuum pump 210 can suppress generation of depositions by heating a vicinity of the thread groove of the thread-groove pump where the gas can be easily deposited when the temperature is lowered, while the stator component remains to be formed of a casting.

In the stator component, the spiral-shaped groove portion having the spiral-shaped ridge portion 243 and the spiral-shaped root portion 244 and the thread-shaped groove portion having the thread-shaped ridge portion 241 and the thread-shaped root portion 242 are formed as the thread-groove pump portion. As a result, in the vacuum pump 210, by providing the heat-transfer improving structure 256 on the stator component, generation of depositions can be suppressed by heating the vicinity of the spiral-shaped groove portion and the thread-shaped groove portion where the depositions can be easily generated when the temperature is lowered.

The reducing groove 255 is located on the surface on the side opposite to the surface on which the thread-groove pump portion of the stator component is formed. As a result, the reducing groove 255 is formed in the vicinity of the thickened thread-groove pump portion of the stator component, while the reducing groove 255 is not faced with a gas channel and thus, the vacuum pump 210 can suppress the deposition on the reducing groove 255 without influencing the exhaustion performance by the reducing groove 255 and effectively maintain the heat transfer to the thread-groove pump portion.

Moreover, the stator component (thread-groove spacer 240) in this embodiment is a stator component which exhausts a sucked-in gas in collaboration with the rotatable rotor 103 of the vacuum pump 210, is formed by casting, has the first part 246 and the second part 245 disposed by sandwiching at least one piece of the reducing groove 255 reducing the volume and extending along the circumferential direction of the stator component, and the bottom portion 258 disposed by including at least the bottom of the reducing groove 255 and connecting the first part 246 and the second part 245, and includes the heat-transfer improving structure 256 which improves the heat transfer between the first part 246 and the second part 245, which are different from the bottom portion 258. As a result, in the stator component, by disposing the reducing groove 255 in the thick part, the speed at which the metal is solidified at casting can be uniformized, generation of a blowhole or a sink mark can be suppressed, and the heat transfer between the first part 246 and the second part 245, which could be lowered by providing the reducing groove 255, can be promoted by the heat-transfer improving structure 256.

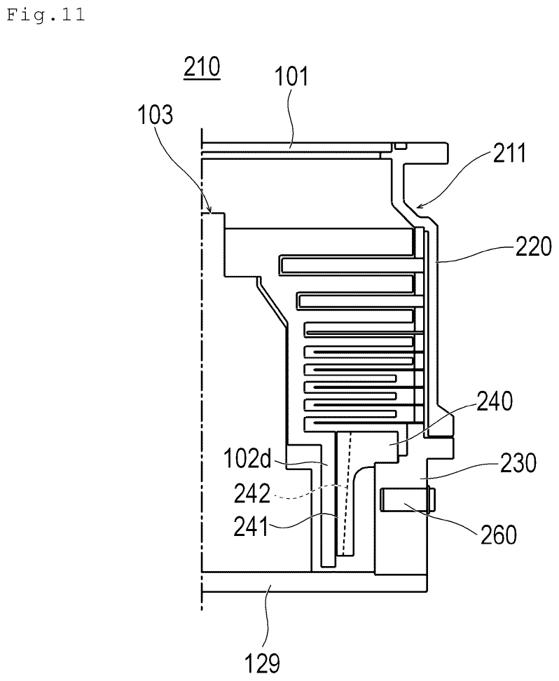

The present invention is not limited only to the embodiment described above but is capable of various changes or combinations by those skilled in the art within the technical idea of the present invention. For example, as in the variation shown in FIG. 11, in the thread-groove spacer 240 (stator member), a part of the Holweck-type thread-groove pump including the thread-shaped ridge portion 241 and the thread-shaped root portion 242 moving in the axial direction while rotating around the shaft may be formed on the inner peripheral surface, and the Siegbahn-type thread-groove pump does not have to be formed on the surface on the upstream side. Moreover, in the thread-groove spacer 240 (stator member), a part of the Siegbahn-type thread-groove pump may be formed on the surface on the upstream side without forming the Holweck-type thread-groove pump on the inner peripheral surface.

Moreover, the heat-transfer improving structure 256 may be formed by a separate member mounted by a method such as fitting, melting or the like into the casting including the first part 246 and the second part 245. In this case, the heat-transfer improving structure 256 may be formed of a material different from the material for forming the casting including the first part 246 and the second part 245. Therefore, the heat-transfer improving structure 256 may be formed of a material having heat conductivity higher than that of the material of the cast part of the stator component. As a result, the vacuum pump 210 can effectively promote the heat transfer between the first part 246 and the second part 245 by the heat-transfer improving structure 256 with high heat conductivity.

Furthermore, as another embodiment of the heat-transfer improving structure 256, substantially the whole of the reducing groove 255 formed by casting or a part of the reducing groove 255 may be filled with a material different from the material forming the casting.

Furthermore, a member which receives the heat by being contacted by the thread-groove spacer 240 (stator member) is not limited to the lower case 230.

Furthermore, the stator member is not limited to the thread-groove spacer 240 but may be a component of a device other than the vacuum pump, for example.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A vacuum pump comprising:
a housing;
a rotor shaft enclosed in the housing and rotatably supported;
a rotor fixed to the rotor shaft and rotated with the rotor shaft; and
an annular stator component which exhausts a sucked-in gas in collaboration with the rotor, wherein
the stator component has a first part and a second part at least partially formed by casting and disposed by sandwiching at least one reducing groove reducing a volume and extending along a circumferential direction of the stator component and a bottom portion disposed by containing at least a bottom of the reducing groove and connecting the first part and the second part; and
the stator component includes a heat-transfer improving structure which improves heat transfer between the first part and the second part, different from the bottom portion.

2. The vacuum pump according to claim 1, wherein
the heat-transfer improving structure is a bridging structure which connects the first part and the second part facing each other with the reducing groove therebetween.

3. The vacuum pump according to claim 1, wherein
the heat-transfer improving structure is formed by a material having a heat conductivity higher than that of a material of the cast part of the stator component.

4. The vacuum pump according to claim 1, wherein
the first part and the second part are disposed to be aligned with the reducing groove sandwiched in a radial direction from a center of the stator component, which is annular.

5. The vacuum pump according to claim 1, wherein
the stator component is a component constituting a thread-groove pump portion.

6. The vacuum pump according to claim 5, wherein
in the stator component, as the thread-groove pump portion, a spiral-shaped groove portion having a spiral-shaped ridge portion and a spiral-shaped root portion and a thread-shaped groove portion having a thread-shaped ridge portion and a thread-shaped root portion are formed.

7. The vacuum pump according to claim 5, wherein
the reducing groove is located on a surface on a side opposite to a surface where the thread-groove pump portion of the stator component is formed.

8. A stator component which exhausts a sucked-in gas in collaboration with a rotatable rotor of the vacuum pump, comprising:
a first part and a second part at least partially formed by casting and disposed by sandwiching at least one reducing groove reducing a volume and extending along a circumferential direction of the stator component and a bottom portion which is disposed by containing at least a bottom of the reducing groove and connects the first part and the second part; and
a heat-transfer improving structure which improves heat transfer between the first part and the second part, different from the bottom portion.
